(19) United States
(12) Patent Application Publication
(10) Pub. No.: US 2003/0016457 A1
(43) Pub. Date: Jan. 23, 2003

(54) Lightweight parabolic mirror

(75) Inventors: Robert Woodall, Panama City Beach, FL (US); Felipe Garcia, Panama City, FL (US)

Correspondence Address: COASTAL SYSTEMS STATION, DAHLGREN DIVISION, NAVAL SURFACE WARFARE CENTER, 6703 W HWY 98 CODE CP2L, PANAMA CITY, FL, 32407-7001, US

(73) Assignee: The United States of America represented by the Secretary of the Navy

(21) Appl. No.: 09/910,276

(22) Filed: Jul. 20, 2001

(51) Int. Cl. G02B 5/08; G02B 7/182; G02B 5/10

(52) U.S. Cl. 359/853; 359/838; 359/846

(57) ABSTRACT

A lightweight parabolic mirror includes an open container with a piece of mirror film sealing the open container such that a sealed chamber is defined. A pressure control system coupled to the sealed chamber maintains a predetermined pressure differential between a pressure inside the sealed chamber and a pressure outside of the sealed chamber. The pressure differential causes the mirror film to deflect parabolically in one of a concave or convex fashion thereby defining the mirror's shape.

### ORIGIN OF THE INVENTION

The invention described herein was made in the performance of official duties by employees of the Department of the Navy and may be manufactured, used, licensed by or for the Government for any governmental purpose without payment of any royalties thereon.

### FIELD OF THE INVENTION

The invention relates generally to parabolic mirrors, and more particularly to a lightweight parabolic mirror design suitable for astronomical use.

### BACKGROUND OF THE INVENTION

Glass-backed mirrors are typically used to gather light in astronomical telescopes in order to view objects at great distances. These mirrors are typically circular parabolic mirrors as they need to focus incoming (nearly) parallel rays of light to a small focus point. The ability to resolve faint objects is directly proportional to the size of the aperture used to gather incoming light. Accordingly, glass-backed mirrors used in such long-distance viewing applications are large, e.g., 3-12 feet in diameter. The use of glass is advantageous given its uniform isotropic structure, low coefficient of thermal expansion, and fine grain structure that provides for a highly polished surface. However, the weight, volume and mass of glass becomes a major structural issue as an optically correct parabolic mirror that is only 3 feet in diameter can weight as much as 400 pounds. As the size of the parabolic mirror increases to accommodate longer distance viewing applications, the weight, volume and mass thereof increases exponentially. For example, large parabolic mirrors up to 12 feet in diameter used in various astronomical observatories can weight several tons or more.

### SUMMARY OF THE INVENTION

Accordingly, it is an object of the present invention to provide a low mass, lightweight parabolic mirror and method for making same.

Another object of the present invention is to provide a lightweight parabolic mirror having good thermal and barometric stability for use in astronomical and/or terrestrial observation.

Yet another object of the present invention is to provide a lightweight parabolic mirror that can hold a near constant focal length over a wide range of temperatures and barometric conditions while minimizing the use of heavy glass to control geometric parameters of the mirror.

Other objects and advantages of the present invention will become more obvious hereinafter in the specification and drawings.

In accordance with the present invention, a lightweight parabolic mirror is provided. A container has an opening formed therein. A piece of mirror film is coupled to the container and seals the opening such that the container and mirror film define a sealed chamber. A pressure control system coupled to the sealed chamber maintains a predetermined pressure differential between a pressure inside the sealed chamber and a pressure outside of the sealed chamber. The pressure differential causes the mirror film to deflect parabolically in one of a concave or convex fashion.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a is a schematic view of one embodiment of a lightweight parabolic mirror according to the present invention; and

FIG. 2 is in part a cross-sectional view and in part a is a schematic view of another embodiment of a lightweight parabolic mirror according to the present invention.

### DETAILED DESCRIPTION OF THE INVENTION

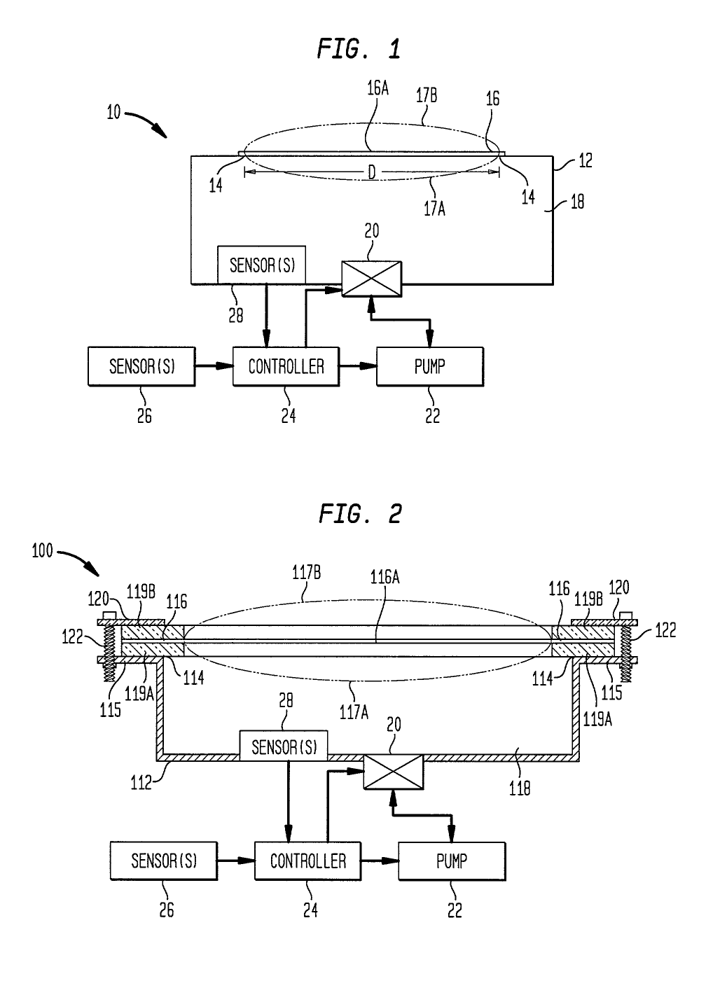

Referring now to the drawings, and more particularly to FIG. 1, a lightweight parabolic mirror according to the present invention is shown and referenced generally by numeral 10. Parabolic mirror 10 can be shaped/sized and used in a wide variety of applications such as astronomical telescopes, tracking systems, lighting devices, holography, photography, spotting scopes, terrestrial observation systems, solar concentrators, reflector antennas and microwave lens antennas.

Parabolic mirror 10 includes a pressure container 12 having an opening 14 formed therein. In the illustrated embodiment, opening 14 is a circular opening of diameter D so that parabolic mirror 10 will be a circular parabolic mirror. However, it is to be understood that other parabolic mirror shapes can be created by the present invention by, for example, making opening 14 define other shapes such as a square, rectangle, pentagon, hexagon, etc.

A piece of thin mirror film 16 covers and seals opening 14 such that the combination of container 12 and mirror film 16 define a sealed chamber 18. For example, mirror film 16 can be captured about the periphery of opening 14. As a result, in the case of a circular opening 14, a circular portion 16A of diameter D of mirror film 16 extends over and across opening 14. Mirror film 16 can be any one of the commercially available thin and flexible mirror films such as the VM2000 mirror film produced by 3M Specialty Film and Media Products Division, St. Paul, Minn.

During construction of parabolic mirror 10, mirror film 16 is attached/sealed to container 12 such that it is relatively flat, i.e., extends directly across opening 14. However, during the use of parabolic mirror 10, circular portion 16A of mirror film 16 is either drawn into sealed chamber 18 or pushed out of sealed chamber 18 as indicated by dashed lines 17A and 17B, respectively, as will be explained further below. Flexing of circular portion 16A is made possible by the thin and flexible nature of mirror film 16.

Parabolic mirror 10 also includes a pressure control system for controlling the pressure in sealed chamber 18. While a representative structure for such a pressure control system will be described herein by way of example, it is to be understood that other pressure control system structures could be used without departing from the scope of the present invention. In principle, the pressure control system maintains a predetermined pressure differential between the ambient pressure P₁ outside of sealed chamber 18 and the pressure P₂ on the inside of sealed chamber 18.

The predetermined pressure differential is selected to parabolically shape circular portion 16A to provide a particular mirror focus for a given application. To deflect circular portion 16A parabolically into sealed chamber 18 to create a concave parabolic mirror as indicated by dashed lines 17A, inside pressure P₂ must be less than outside pressure P₁. Conversely, to deflect circular portion 16A parabolically out of sealed chamber 18 to create a convex parabolic mirror as indicated by dashed line 17B, inside pressure P₂ must be greater than outside pressure P₁. To insure that all pressure differential deflection occurs only at circular portion 16A, container 12 must maintain its shape at the predetermined pressure differential.

One embodiment of the pressure control system for maintaining the predetermined pressure differential includes: a controllable valve 20 installed in container 12 to communicate with sealed chamber 18, a pump 22 coupled to valve 20, a controller 24 coupled to valve 20 and pump 22 to control the operation thereof based on pre-programmed control logic/algorithm(s), and sensor(s) 26 and 28 that provide pressure measurements (and/or other measurements such as temperature which are indicative of pressure measurements) of outside pressure P₁ and inside pressure P₂, respectively.

In operation, controller 24 is pre-programmed with the predetermined pressure differential (P₁-P₂) needed to shape circular portion 16A of mirror film 16. Based on readings from sensor(s) 26 and 28, controller 24 controls the opening/closing of valve 20 and the operation of pump 22 to reduce or increase pressure in sealed chamber 18. Accordingly, pump 22 is typically a reversible pump. The particular fluid medium pumped into or out of sealed chamber 18 is not a limitation of the present invention. While any inert fluid will do, a gas such as air is preferred to minimize the overall weight of parabolic mirror 10.

To maintain the correct parabolic shape defined by either of dashed lines 17A or 17B, it is necessary to maintain the diameter of circular portion 16A as well as the above-described pressure differential. This is especially true in larger diameter mirrors. One way of fixing the diameter of circular portion 16A is illustrated in the embodiment of FIG. 2 where like reference numerals are used for those elements that are common with the FIG. 1 embodiment.

In FIG. 2, a parabolic mirror 100 includes a rigid pressure container 112 (e.g., metal, plastic, composite, etc.) having an opening 114 formed therein. Container 112 includes a peripheral lip 115 provided about opening 114. Unlike parabolic mirror 10, opening 114 is not used to define the shape of the parabolic mirror. Rather, a piece of thin mirror film 116 is captured/sandwiched at its periphery between two glass rings 119A and 119B which are aligned with one another to define a constant inside diameter D that defines a circular portion 116A of mirror film 116. Since glass is a very isotropic material with a small coefficient of thermal expansion, the diameter D of circular portion 116A will remain constant to assure a constant aperture for parabolic mirror 100 while adding only a small amount of extra weight to the overall mirror assembly. Note that the lower glass ring 119A can have its inner periphery shaped to facilitate a particular parabolic shape and to provide a smooth edge adjacent mirror film 116. In addition, as in the previous embodiment, the shape defined by the inner periphery of rings 119A and 119B (which defined the shape of the mirror film deflected by the pressure differential) need not be circular.

The combination of glass rings 119A and 119B sandwiching mirror film 116 is clamped to peripheral lip 115 by, for example, the use of a clamping ring 120 and clamping screws 122 cooperating with clamping ring 120 and peripheral lip 115. As a result, a sealed chamber 118 is defined within the combination of container 112 having glass rings 119A/119B and mirror film 116 sealing opening 114. Parabolic mirror 100 includes a pressure control system similar to that described above with respect to parabolic mirror 10 and will, therefore, not be described further herein. Thus, during operation of parabolic mirror 100, circular portion 116A of mirror film 116 can be deflected parabolically into or out of sealed chamber 118 as indicated by dashed lines 117A and 117B, respectively.

The advantages of the present invention are numerous. A lightweight parabolic mirror and method of constructing/operating same are provided. The parabolic mirror will adapt to a wide variety of pressure and/or temperature variations. The simple lightweight construction will allow the present invention to be used in portable as well as permanent telescope, tracking system assemblies, etc. The materials used in the present invention are readily available and relatively inexpensive. The light weight of the mirror assembly opens up the possibility of very large diameter apertures since the weight of the overall mirror assembly is more than 500 times lighter than conventional glass-backed mirror assemblies. Further, since the mirror film is thin and has little thermal mass, it stabilizes quickly (e.g., on the order of 1-2 seconds) and homogeneously in varying temperature conditions.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A parabolic mirror comprising:
a container having an opening formed therein;
a piece of mirror film coupled to said container and sealing said opening wherein said container and said mirror film define a sealed chamber; and
a pressure control system coupled to said sealed chamber for maintaining a predetermined pressure differential defined as a difference between a pressure inside said sealed chamber and a pressure outside of said sealed chamber, wherein said pressure differential causes said mirror film to deflect parabolically.

2. A parabolic mirror as in claim 1 further comprising:
a pair of glass rings sandwiched about said mirror film; and
means for attaching said pair of glass rings with said mirror film sandwiched therebetween to said container and over said opening.

3. A parabolic mirror as in claim 1 wherein said pressure control system comprises:
a controllable valve coupled to said sealed chamber;
a reversible pump coupled to said controllable valve; and
a controller coupled to said controllable valve and said reversible pump for monitoring said pressure inside said sealed chamber and said pressure outside of said sealed chamber, said controller controlling said controllable valve and said reversible pump based on said pressure differential.

4. A parabolic mirror as in claim 3 wherein said reversible pump is an air pump, and wherein said sealed chamber is filled with air.

5. A parabolic mirror as in claim 1 wherein said pressure inside said sealed chamber is maintained at a level greater than said pressure outside of said sealed chamber.

6. A parabolic mirror as in claim 1 wherein said pressure inside said sealed chamber is maintained at a level less than said pressure outside of said sealed chamber.

7. A parabolic mirror as in claim 1 wherein said opening is circular.

8. A parabolic mirror comprising:
a container having an opening formed therein;
a piece of mirror film;
a pair of glass rings aligned with one another and sandwiched about said mirror film wherein a circular portion of said mirror film extends across an inside diameter of said pair of glass rings;
means for clamping said pair of identically-sized glass rings with said mirror film sandwiched therebetween to said container and over said opening wherein said container and said pair of identically-sized glass rings with said mirror film sandwiched therebetween define a sealed chamber; and
a pressure control system coupled to said sealed chamber for maintaining a predetermined pressure differential defined as a difference between a pressure inside said sealed chamber and a pressure outside of said sealed chamber, wherein said pressure differential causes said circular portion of said mirror film to deflect parabolically.

9. A parabolic mirror as in claim 8 wherein said pressure control system comprises:
a controllable valve coupled to said sealed chamber;
a reversible pump coupled to said controllable valve; and
a controller coupled to said controllable valve and said reversible pump for monitoring said pressure inside said sealed chamber and said pressure outside of said sealed chamber, said controller controlling said controllable valve and said reversible pump based on said pressure differential.

10. A parabolic mirror as in claim 9 wherein said reversible pump is an air pump, and wherein said sealed chamber is filled with air.

11. A parabolic mirror as in claim 8 wherein said pressure inside said sealed chamber is maintained at a level greater than said pressure outside of said sealed chamber.

12. A parabolic mirror as in claim 8 wherein said pressure inside said sealed chamber is maintained at a level less than said pressure outside of said sealed chamber.

13. A method of making a parabolic mirror, comprising the steps of:
providing a container having an opening formed therein;
attaching a piece of mirror film over said opening so that a shaped portion of said mirror film is defined and extends over said opening, wherein said container and said mirror film define a sealed chamber; and
controlling pressure in said sealed chamber in accordance with a predetermined pressure differential defined as a difference between a pressure inside said sealed chamber and a pressure outside of said sealed chamber, wherein said pressure differential causes said shaped portion of said mirror film to deflect parabolically.

14. A method according to claim 13 wherein said step of controlling pressure comprises the step of maintaining said pressure inside said sealed chamber at a level greater than said pressure outside of said sealed chamber.

15. A method according to claim 13 wherein said step of controlling pressure comprises the step of maintaining said pressure inside said sealed chamber at a level less than said pressure outside of said sealed chamber.

16. A method according to claim 13 wherein said sealed chamber is filled with a fluid medium, and wherein said step of controlling pressure comprises the step of regulating a flow of said fluid medium into and out of said sealed chamber.

17. A method according to claim 16 wherein said fluid medium is air.
